(19) United States
(12) Patent Application Publication
(10) Pub. No.: US 2017/0298890 A1
(43) Pub. Date: Oct. 19, 2017

(54) SYSTEMS AND METHODS FOR UNINTERRUPTABLE POWER SUPPLY

(71) Applicant: The Wise Labs, Inc., Schenectady, NY (US)

(72) Inventor: Robert D. King, Schenectady, NY (US)

(73) Assignee: The Wise Labs, Inc., Schenectady, NY (US)

(21) Appl. No.: 15/491,736

(22) Filed: Apr. 19, 2017

Related U.S. Application Data
(60) Provisional application No. 62/324,856, filed on Apr. 19, 2016.

(51) Int. Cl. F02N 11/08; H02J 7/00; H02J 9/06; H02J 7/34

(52) U.S. Cl. CPC F02N 11/0862; H02J 7/0021; H02J 9/062; F02N 2011/0896; H02J 7/345

(57) ABSTRACT

The disclosure provides an uninterruptable power supply (UPS) system for use with a vehicle with an internal combustion engine, an onboard first energy storage device configured to store and provide DC electrical power for at least one of cranking and starting the engine, and a charging device configured to provide a recharging power to the first energy storage device. The UPS system includes a second energy storage device configured to store and provide DC electrical power, and a DC interface electrically coupled between the first and second energy storage devices. The UPS system further includes a DC-AC inverter electrically coupled to the second energy storage system configured to invert the DC power to AC power, an AC power interface electrically coupled to the DC-AC inverter configured to provide an electrical connection to an external load, and a control system configured to selectively operate the charging device of the vehicle.

### FIELD OF THE INVENTION

The present disclosure is generally directed to systems and related methods for supplying electrical power. More particularly, the present disclosure is directed to vehicle- and/or engine-based systems and related methods for uninterruptable electrical power supply.

### BACKGROUND OF THE INVENTION

Non- or off-grid sources of electrical power are known as important devices in various applications and industries for providing power when grid-based power is not available. For example, off-grid sources of electrical power provide safeguards against power outages, provide for temporary power, and/or provide for portable power. It is recognized that the need for dependable and relatively long-lasting sources of off-grid power may increase in the near future as utility grid failures become more prevalent, for example. That is, due to the number and severity of storms (lightning, wind, fallen trees, ice, etc.), the overload of the country's aging utility's transmission and distribution components, and/or the potential threat of terrorism, the likelihood of utility grid failures is increasing. As another example, as the proliferation of electrical devices has increased, the need for electrical power sources in areas or locations that lack access to grid power has also increased in order to power the electrical devices. Still further, emission and/or noise pollution restrictions and concerns have limited the availability and/or desirability of traditional fuel-powered portable generators. Such traditional fuel-powered portable generators, such as a gasoline, diesel, propane, or other fueled versions of an auxiliary or emergency generator, are typically interfaced via a transfer switch to a subset of electrical circuits in a dwelling to provide emergency power and/or provide an interface with traditional electric outlets for plug and socket type electrical connections.

One source of off-grid power is an Uninterruptible Power Supply (UPS). A UPS is preferred in some instance to generators, for example, as a UPS maintains a continuous supply of electric power to connected equipment by supplying power from a separate source when utility power is not available, as compared to an auxiliary power supply or a standby generator, which do not provide instant protection from a momentary power interruption as is desired for certain types of equipment. For example, a UPS is typically used to protect computers, telecommunication equipment, medical equipment, or other electrical equipment where an unexpected power disruption could cause serious business disruption or data loss, pose other significant consequence, or simply an inconvenience.

It is recognized, however, that UPS systems have their limitations. A key issue with conventional UPS systems is whether the limited amount of energy that is stored in the UPS's battery is sufficient to operate the device for an extended period of time. For example, individuals that require the use of portable AC powered medical equipment and health monitors need a backup source of power that can last for the duration of the night (depending on the specific medical equipment required) or in a worst case, for the duration of a utility grid failure. Devices such as constant pressure airway passages (CPAP), oxygen concentrators, portable respirators, and heart monitors, need to be ensured of a proper supply of power in order to ensure patient well-being. As the average age of the population increases, there is also an increasing need for such critical care devices and systems, and thereby an associated need for systems that can provide adequate, extended length powering of those devices during utility grid outages. Many other non-medical electrical power needs also require or prefer an uninterrupted power supply over an extended period of time.

Therefore, it is desirable to design a UPS system that provides extended power for external loads when utility grid power is unavailable. It is further desired that such a UPS system provide a steady power source and be maintained at a desirable state of charge (SOC) and/or at or above minimum voltage. Still further, a UPS system that is more convenient, portable, quiet and/or environmentally friendly as compared to traditional auxiliary power supplies or standby generators is also desirable.

### SUMMARY OF THE INVENTION

In one aspect, the present disclosure provides an uninterruptable power supply (UPS) system for use with a vehicle with an internal combustion engine, an onboard first energy storage device configured to store and provide DC electrical power for at least one of cranking and starting the engine of the vehicle and powering auxiliary devices of the vehicle, and a charging device configured to provide a recharging power to the first energy storage device. The system includes a second energy storage device, a DC interface, a DC-AC inverter, an AC power interface, and a control system. The second energy storage device is configured to store and provide DC electrical power. The DC interface is electrically coupled between the first energy storage device and the second energy storage device, and is configured to control the transfer of DC electrical power between the first energy storage device and the second energy storage device. The DC-AC inverter is electrically coupled to the second energy storage system and configured to receive the DC power therefrom and invert the DC power to AC power. The AC power interface is electrically coupled to the DC-AC inverter and configured to receive the AC power therefrom and provide an electrical connection to an external load. The control system is configured to cause the AC power interface to provide uninterrupted AC power to the external load from at least the second energy storage device, and to determine at least one of a state-of-charge (SOC) and a voltage of each of the first energy storage system and the second energy storage system while the uninterrupted AC power is provided to the external load. The control system is further configured to, based on the at least one of the SOC and the voltage of the first energy storage system, selectively operate the internal combustion engine to operate the charging device of the vehicle to provide the recharging power to the first energy storage system to maintain at least one of the SOC and the voltage of the first energy storage system at or above a first threshold. The control system is further configured to, based on the at least one of the SOC and the voltage of the second energy storage system, selectively operate the internal combustion engine and the DC interface to operate the charging device of the vehicle to provide the recharging power to the first energy storage system and transfer the DC electrical power from the first energy storage system to the second energy storage system to maintain the at least one of the SOC and the voltage of the second energy storage system at or above a second threshold.

In some embodiments, the first energy storage device is at least one starting-lighting-ignition (SLI) battery with a reserve capacity of at least 80 minutes and at least 500 cold cranking amperes. In some embodiments, the second energy storage device includes at least one battery. In some such embodiments, the second energy storage device includes at least one high-specific energy battery or a high-specific power battery. In some other such embodiments, the second energy storage device further includes at least one ultracapacitor energy storage device.

In some embodiments, the control system is configured to determine the SOC and the voltage of each of the first energy storage system and the second energy storage system while the uninterrupted AC power is provided to the external load. In some such embodiments, the control system is configured to, based on the SOC and the voltage of the first energy storage system, selectively operate the internal combustion engine and the charging device of the vehicle to provide the recharging power to the first energy storage system to maintain at least one of the SOC and the voltage of the first energy storage system at or above a first threshold of the SOC and the voltage of the first energy storage system. In some other such embodiments, the control system is configured to, based on the SOC and the voltage of the second energy storage system, selectively operate the internal combustion engine and the charging device of the vehicle and the DC interface to provide the recharging power to the first energy storage system and to transfer the DC electrical power from the first energy storage system to the second energy storage system to maintain the at least one of the SOC and the voltage of the second energy storage system at or above a second threshold of the SOC and the voltage of the second energy storage system.

In some embodiments, the DC interface electrically decouples or substantially reduces the level of DC electrical power transfer from the on-board energy storage system to the second energy storage system while the onboard first energy storage device provides DC electrical power for at least one of cranking and starting the engine of the vehicle. In some embodiments, the control system is at least one of activated and deactivated by a user via a wired or wireless switch. In some such embodiments, the control system is configured to at least one of automatically deactivate and automatically reactivate after a deactivation based on at least one sensed parameter. In some embodiments, the DC interface is at least one of a MOSFET transistor and a DC-DC converter.

In some embodiments, the system is configured to mechanically and electrically fixedly couple to the vehicle. In some embodiments, the system is configured to electrically removably couple to the vehicle. In some such embodiments, the system further includes a transportation system configured to physically transport the system from the vehicle to a separate location remote from the vehicle when the system is electrically decoupled from the vehicle. In some embodiments, the system further includes the vehicle.

In another aspect, the present disclosure provides a vehicle including an internal combustion engine, a first energy storage device, a charging device, a second energy storage device, a DC interface, a DC-AC inverter, an AC power interface, and a control system. The first energy storage device is configured to store and provide DC electrical power for at least one of cranking and starting the engine of the vehicle and powering auxiliary devices of the vehicle. The charging device is configured to provide a recharging power to the first energy storage device. The second energy storage device is configured to store and provide DC electrical power. The DC interface is electrically coupled between the second energy storage device and the first energy storage device and is configured to control the transfer of DC electrical power between the first energy storage device and the second energy storage device. The DC-AC inverter is electrically coupled to the second energy storage system and is configured to receive the DC power therefrom and invert the DC power to AC power. The AC power interface is electrically coupled to the DC-AC inverter and is configured to receive the AC power therefrom and provide an electrical connection to an external load. The control system is configured to cause the AC power interface to provide uninterrupted AC power to the external load via at least the second energy storage device, and to determine at least one of a state-of-charge (SOC) and a voltage of each of the first energy storage system and the second energy storage system while the uninterrupted AC power is provided to the external load. The control system is further configured to selectively operate the charging device of the vehicle and the DC interface to provide the recharging power to the first energy storage system and the DC power to the second energy storage system to maintain the at least one of the SOC and the voltage of each of the first energy storage system and the second energy storage system at or above a first threshold while maintaining the uninterrupted AC power to the external load.

In another aspect, the present disclosure provides a method for supplying uninterruptable power. The method includes detecting a connection of an external load to an uninterruptable power supply (UPS) system coupled to a first energy storage system of a vehicle that is configured to store and provide DC electrical power for at least one of cranking and starting an engine of the vehicle and powering auxiliary devices of the vehicle. The method further includes providing AC power from at least a second energy storage system of the UPS system to the external load. The method also includes detecting at least one of a voltage and a state of charge (SOC) of each of the first and second energy storage systems. The method further includes, if the at least one of the voltage and the SOC of the first energy storage system is below at least one first threshold, activating a charging device of the vehicle coupled to the first energy storage system to supply a recharging power thereto until the at least one of the voltage and the SOC of the first energy storage system is at or above at least one second threshold while at least the second energy storage system provides power to the external load. The method also includes, if the at least one of the voltage and the SOC of the second energy storage system is below at least one third threshold, activating the charging device of the vehicle and activating a DC interface of the UPS system coupled between the first energy storage system and the second energy storage system to transfer DC electrical power from the first energy storage device to the second energy storage device until the at least one of the voltage and the SOC of the second energy storage system is at or above at least one fourth threshold while at least the second energy storage system provides power to the external load.

In another aspect, the present disclosure provides a control system for controlling the supply of uninterrupted power from a first energy storage system of an uninterruptable power supply (UPS) system to an external load, the UPS system being coupled to a vehicular on-board second energy storage system. The control system is configured or programmed to detect connection of the external load to the first energy storage system of the UPS system. The control system is further configured or programmed to measure at least one of a voltage and a state of charge (SOC) of the first energy storage system upon connection of the external load. The control system is also configured or programmed to measure at least one of a voltage and a state of charge (SOC) of the second energy storage system. The control system is further configured or programmed to selectively activate a vehicular charging device connected to the second energy storage system if the at least one of the voltage and the SOC thereof is at or below at least one first threshold to supply a recharging power thereto until the at least one of the voltage and the SOC of the second energy storage system is at or above at least one second threshold. The control system is also configured or programmed to selectively activate the vehicular charging device and selectively activate a DC interface of the UPS system coupled between the first energy storage system and the second energy storage system if the at least one of the voltage and the SOC of the first energy storage system is at or below at least one third threshold to supply a recharging power thereto until the at least one of the voltage and the SOC of the first energy storage system is at or above at least one fourth threshold while at least the first energy storage system provides uninterrupted power to the external load.

In some embodiments, the control system may be further programmed to be at least one of activated and deactivated by a user via a wired or wireless switch. In some embodiments, the control system may be further programmed to at least one of automatically deactivate and automatically reactivate after a deactivation based on at least one sensed parameter.

These and other objects, features and advantages of this disclosure will become apparent from the following detailed description of the various aspects of the disclosure taken in conjunction with the accompanying drawings.

### BRIEF DESCRIPTION OF THE DRAWINGS

For the purposes of illustrating the vehicle- and/or engine-based uninterruptable electrical power supply systems and related methods described herein, there is shown herein illustrative embodiments. These illustrative embodiments are in no way limiting in terms of the precise arrangement and operation of the disclosed vehicle- and/or engine-based uninterruptable electrical power supply systems and related methods and other similar embodiments are envisioned within the spirit and scope of the present disclosure.

FIG. 1 is a block schematic diagram of an exemplary embodiment of an engine-based uninterruptable power supply (UPS) system according to the present disclosure;

FIG. 2 is a block schematic diagram of another exemplary embodiment of an engine-based UPS system according to the present disclosure;

FIG. 3 is a block schematic diagram of an exemplary embodiment of a DC interface of the engine-based UPS system of FIG. 1 according to the present disclosure;

FIG. 4 is a block schematic diagram of another exemplary embodiment of a DC interface of the engine-based UPS system of FIG. 1 according to the present disclosure;

FIG. 5 is a block schematic diagram of another exemplary embodiment of an engine-based UPS system according to the present disclosure; and

FIG. 6 is a block schematic diagram of another exemplary embodiment of an engine-based UPS system according to the present disclosure.

### DETAILED DESCRIPTION

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of parameters are not exclusive of other parameters of the disclosed embodiments. Components, aspects, features, configurations, arrangements, uses and the like described, illustrated or otherwise disclosed herein with respect to any particular embodiment may similarly be applied to any other embodiment disclosed herein.

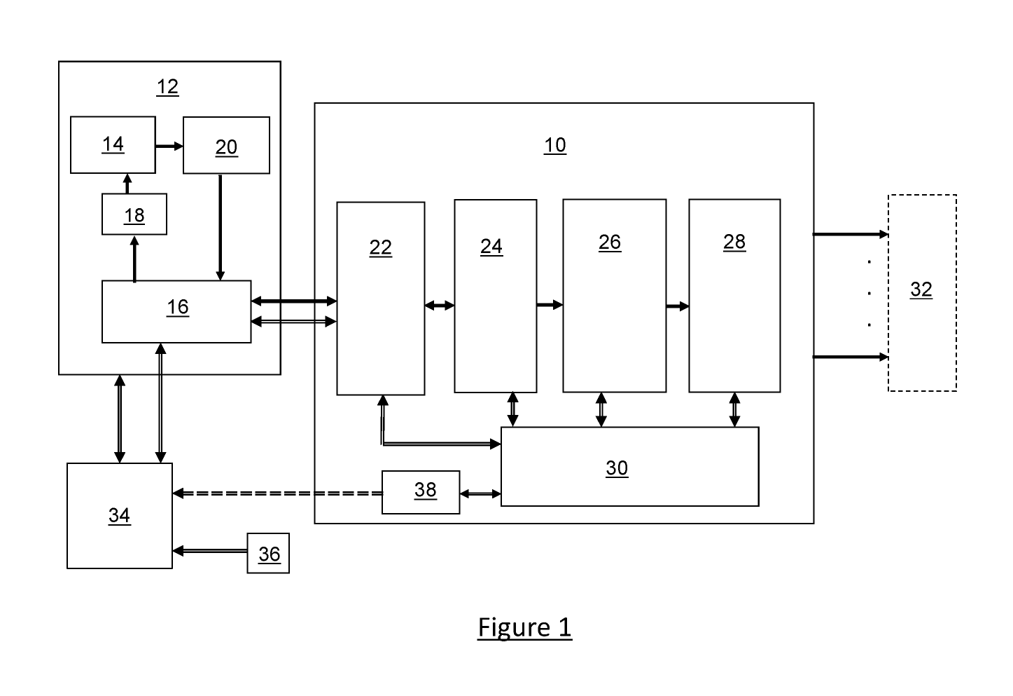

As shown in FIG. 1, embodiments of systems and related methods for uninterruptable electrical power supply (UPS) 10 according to the present disclosure are configured for use with a motor vehicle 12. In some embodiments, the propulsion system of the vehicle 12 may include an internal combustion engine 14 for effectuating motion of the vehicle 12. In other embodiments, the propulsion system of the motor vehicle 12 may include a power generating mechanism other than an internal combustion engine 14 for effectuating motion of the vehicle 12, such as, for example, a fuel cell, a flywheel, or an external combustion heat engine. The vehicle 12 may be any mobile machine configured to transports people and/or cargo via the propulsion system. Typical vehicles include, for example, motor vehicles (motorcycles, cars, trucks, buses, tractors, etc.), railed vehicles (trains, trams, etc.), watercraft (ships, boats, etc.), aircraft and spacecraft. The vehicle may also be any motorized apparatus and equipment, and may or may not be configured to transport people and/or cargo.

As shown in FIG. 1, the vehicle 12 may also include an on-board energy storage system or device 16 including one or more electrical energy storage units. In some embodiments, the on-board energy storage system 16 may effectuate starting and cranking and/or operation of the internal combustion engine 14 of the vehicle 12 via a starter mechanism 18. The on-board energy storage system 16 may also operate accessories of the vehicle 12. For example, a vehicle 12 with an internal combustion engine 14, such as part of the propulsion system, may utilize at least one starting, lighting and/or ignition (SLI) battery, such as a lead-acid battery, to perform engine cranking, starting and operate vehicle accessories both while the vehicle 12 is parked and not being operated and also while being operated with the engine 14 running. Accessory loads while the vehicle 12 is not being operated (e.g., before the internal combustion engine 14 is started) may include on-board computer(s), security systems, lights, remote starters, engine ignition, fire detection/fire prevention systems, sensors, etc., for example. Accessory loads while the vehicle 12 is being operated (e.g., after the internal combustion engine 14 is started) may include engine ignition, headlights, cooling fans, power windows, power seats, window defrosters, air conditioning components, on-board entertainment, cameras, etc., for example. The on-board energy storage system 16 may include a single battery (e.g., an SLI battery), or multiple batteries including at least one SLI battery, such as an SLI battery and a larger voltage battery.

Typical SLI batteries are characterized by Cold Cranking Amperes (CCA) and Reserve Capacity (RC). A reserve capacity for a typical nominal 12V SLI battery, for example, is a specified rating of the number of minutes the SLI battery can supply a constant current of 25 Amps, with a temperature of 80 degrees F., until the SLI battery voltage drops to 10.5 Volts. RC values of a typical motor vehicle SLI battery may range from about 80 to about 100+ minutes, and include CCA values of at least 500 Amperes. A new SLI battery at a temperature of 80 degrees F. (with the engine 14 and/or alternator 20 of the vehicle 12 not running) thereby typically can provide an average of approximately 300 W of power within the range of about 80 to about 100 minutes, or within the range of about 400 to about 500 Watt hour (Wh) of electrical energy. As a result, the available stored energy in a typical SLI storage battery limits the use of the battery as a power supply, such as an uninterruptible power supply, for medical or other equipment requiring approximately about 150 W to about 200 W to only a few hours, requiring approximately about 300 W to about 400 W to a fraction of an hour, and requiring about 600 to about 1,000 W to a few tens of minutes. Other on-board batteries, such as higher voltage batteries (e.g., 48V batteries) also may not contain sufficient available stored energy for high energy loads.

As noted above, the on-board energy storage system 16 of the vehicle 12 may be utilized, at least in part, to startup and/or operate the internal combustion engine 14 of the vehicle 12 via a starter mechanism 18 for starting or initiating operation the internal combustion engine 14 as described above. For example, an SLI battery 16 is typically utilized in motor vehicles 12 to crank the combustion engine 14 via a starter motor 18, as shown in FIG. 1. In some other embodiments, the vehicle's internal combustion engine 14 may not be part of the propulsion system of the vehicle 12, such as part of a generator of the like provided on the vehicle 12. A conventional motor vehicle's on-board energy storage or SLI battery 16 is thereby typically capable of supplying substantial power and energy to crank and start the engine 14 (which may or may not be part of the propulsion system(s) of the vehicle 12), accessory loads, and/or charging system(s) 20 of the vehicle 12, requiring several hundred Amperes (e.g., CCA values of 500+ Amperes) for relatively short time periods typically measured in fractions of minutes and a relatively small level of continuous discharge power (about 300 W) and low energy storage capacity (Wh). As result, a typical motor vehicle SLI battery's chemistry has been optimized to provide high cranking current function (high specific power) but with reduced specific energy. Therefore, the on-board charging device or mechanism 20 of the vehicle 12 may be configured to selectively operate to prevent excessive deep discharge of the SLI battery that will prevent it from high cranking current function and/or dramatically reduce lifespan.

The vehicle's on-board charging device or unit (e.g., an alternator) 20 for charging the on-board energy storage system 16 may be powered by the vehicle's internal combustion engine 14, which may or may not be part of the propulsion system of the vehicle 12. For example, as shown in FIG. 1 an engine-driven alternator 20 of a vehicle 12 may supply electrical power to the SLI battery 16 to maintain the voltage and state of charge thereof such that it can provide the high cranking current function to the engine 14 via the starter motor 18.

As shown in FIG. 1, a power supply system or uninterruptable power supply (UPS) system 10 of the present disclosure may be configured for use with a vehicle 12 including the an internal combustion engine 14 (that may or may not effectuate motion of the vehicle 12), the on-board energy storage system 16 that effectuates cranking and starting and/or operation of the internal combustion engine 14 and/or operates accessories of the vehicle 12, the on-board charging device or unit 20 for charging the on-board energy storage system 16 via the internal combustion engine 14, and the starter mechanism 18 for cranking and starting or initiating operation the internal combustion engine 14 as described above. For example, a power supply system or uninterruptable power supply (UPS) system 10 of the present disclosure may be configured for use with a vehicle 12 including an internal combustion engine 14 that effectuates motion of the vehicle 12, an SLI battery 16 that effectuates cranking and starting and/or operation of the engine 14 and operates accessories of the vehicle 12, an alternator 20 for charging the SLI battery 16 via the engine 14, and a starter motor 18 for cranking the engine 14 to initiate operation thereof.

Referring to FIG. 1, a block schematic diagram of a vehicle- and/or engine-based power supply or uninterruptable power supply (UPS) system 10 is shown as incorporated into the vehicle 12. In some embodiments, the system 10 may be configured to be installed or utilized with a pre-existing vehicle 12, such as an add-on kit or installation. In some other embodiments, the system 10 may be pre-installed or manufactured with the vehicle 12, such as a factory option.

As shown in FIG. 1, the power supply system 10 may include, at least, a second energy storage system 24, a DC interface 22 electrically coupled between the first onboard energy storage device 16 and the second energy storage device 24 to allow or provide for the transfer of DC electrical power between the first energy storage device 16 and the second energy storage device 24, a DC-AC inverter 26, an AC power interface 28, and a control system or controller 30. As noted above, the first onboard energy storage device 16 (e.g., at least one SLI battery, such as a typical 12 V SLI motor vehicle battery) may be configured to provide electric power for driving one or more starter mechanism 18 of the engine 14 of the vehicle 12 and/or provide electric power to auxiliary devices (e.g., lights, windshield wipers) of the vehicle 12. The power supply system 10 may further utilize the first onboard energy storage device 16 to provide a recharging power to the second energy storage device 24 and, potentially, provide a supply of uninterruptable power to at least one external load 32 via the interface 28 if the load 32 is above what can be provided by the second energy storage device 24, for example.

The DC interface 22 electrically coupled between the first onboard energy storage device 16 and the second energy storage device 24 may be configured to selectively control the transfer of DC electrical power from the first on-board energy storage device 16 to the second energy storage device 24 when a recharging and/or supplemental power supply is needed, as explained further below. The DC interface 22 electrically coupled between the first onboard energy storage device 16 and the second energy storage device 24 may also configured to selectively control the transfer of DC electrical power from the second energy storage device 24 to the first on-board energy storage device 16 under certain conditions.

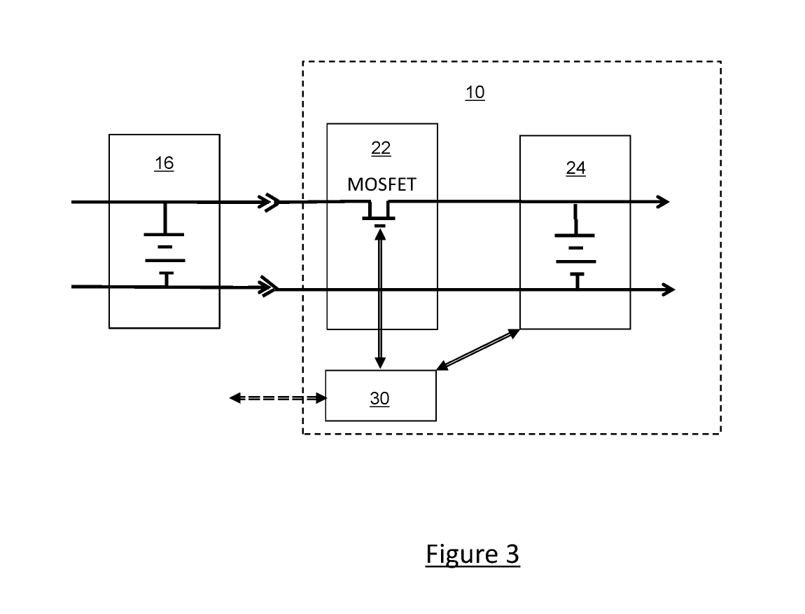

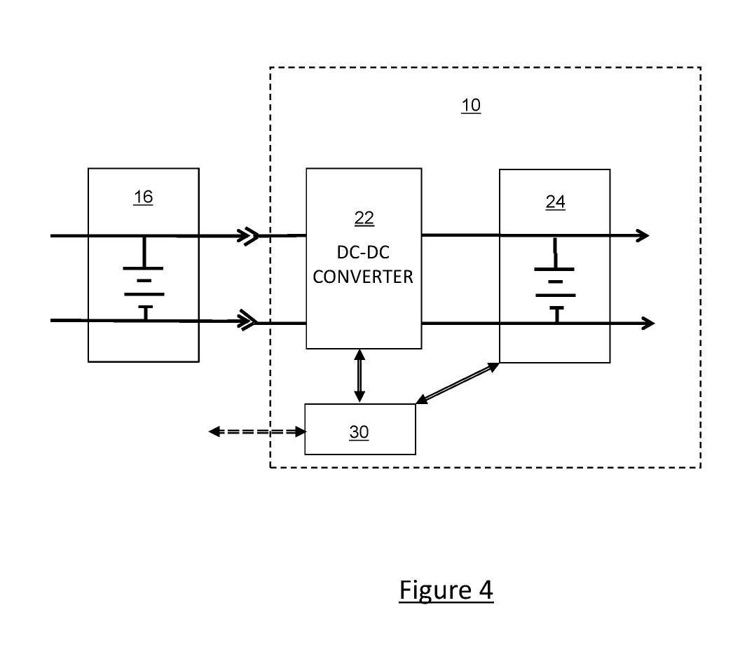

In some embodiments, the DC interface 22 may be a diode or a switch mechanism controlled by the controller 30 to selectivity couple or decouple the first onboard energy storage device 16 and the second energy storage device 24 in electrical contact. For example, as shown in FIG. 3 the DC interface 22 may be a MOSFET transistor that is controlled by the controller 30. As another example, as shown in FIG. 4 the DC interface 22 may be a DC-DC converter or a DC-DC converter in combination an electric/electronic or physical switch (not shown). The system 10 or one or more components thereof, such as the DC interface 22, the second energy storage device 24, the DC-AC inverter 26, the AC power interface 28 and/or the controller 30, may be on-board the vehicle 12, such as permanently or fixedly attached or coupled to the vehicle 12 (e.g., fixedly mechanically and/or electrically coupled). In other embodiments, the system 10 or one or more components thereof, such as the DC interface 22, the second energy storage device 24, the DC-AC inverter 26, the AC power interface 28 and/or the controller 30, may be configured as an add-on component or accessory that may be removably coupled (e.g., removably mechanically and/or electrically coupled) and/or fixedly coupled (e.g., fixedly mechanically and/or electrically coupled) to the vehicle 12. For example, in some embodiments the system 10 or one or more components thereof, such as the DC interface 22, the second energy storage device 24, the DC-AC inverter 26, the AC power interface 28 and/or the controller 30, may not be physically or mechanically coupled or affixed to the vehicle 12 during use and only be electrically coupled to the vehicle 12 (e.g., electrically coupled to the first energy storage device 16, starter mechanism 18, etc.).

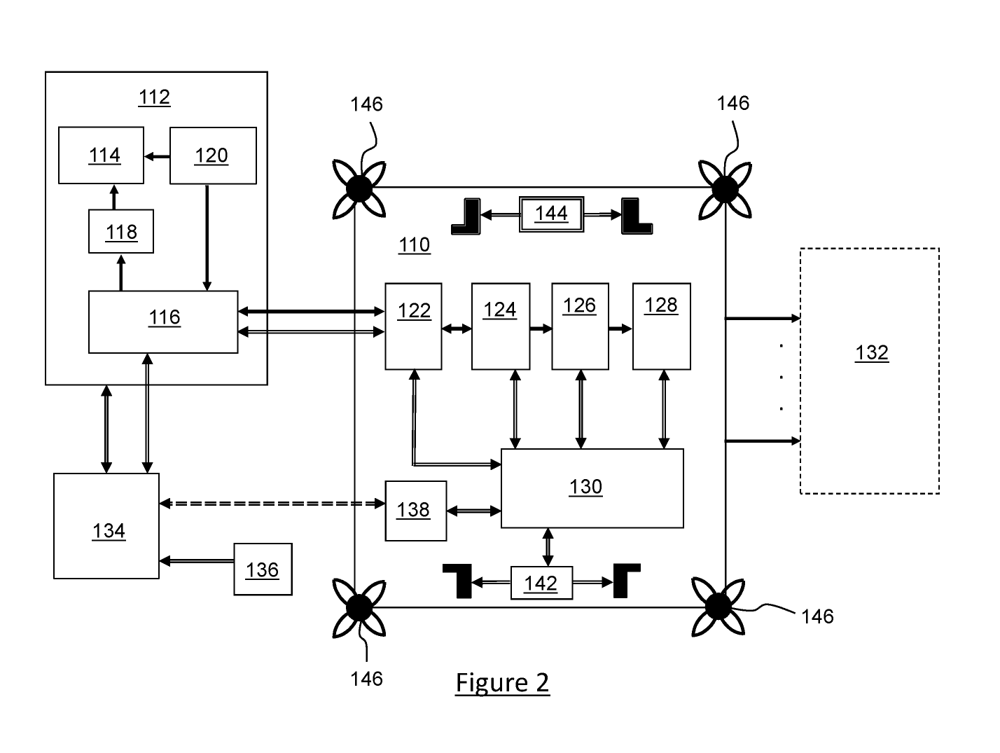

FIG. 2 illustrates one exemplary embodiment in which the system 110 or one or more components thereof, such as the second energy storage device 124, DC-AC inverter 126, AC power interface 128 and/or the controller 130, may be configured as an add-on component or accessory that may be removably coupled (e.g., removably mechanically and/or electrically coupled) to the vehicle 112. The exemplary UPS system 110 of FIG. 2 is substantially similar to the exemplary UPS system 10 of FIG. 1, and therefore like reference numerals preceded by the numeral “1” are used to indicate like elements. The description herein with respect to the exemplary UPS system 10 of FIGS. 1, 3 and 4 equally applies to the exemplary UPS system 110 of FIG. 2, including description regarding alternative embodiments thereto (i.e., modifications, variations or the like). The exemplary UPS system 110 of FIG. 2 differs from the exemplary UPS systems 10 and 210 with respect to the configuration of the operation of the internal combustion engine 214 and the recharging of the on-board first energy storage system 216. As shown in FIG. 2, the UPS system 110 may be configured to mechanically and/or electrically removably or releasably couple to the vehicle 112 via a first controlled release mechanism 142 of the system 110. The first release mechanism 142 may be configured to at least removably electrically couple the system 110 to the first on-board energy storage device 116 of the vehicle 112, as discussed above. In some embodiments, the first release mechanism 142 may also be configured to removably mechanically or physically couple the system 110 to the vehicle 112.

As shown in FIG. 2, the first release mechanism 142 may be in communication with the controller 130 of the system 110. In some such embodiments, the controller 130 may control operation of the first release mechanism 142 to effectuate or allow mechanical and/or electrical decoupling of the system 110 from the vehicle 112. From a coupled state, the first release mechanism 142 may thereby effectuate selective mechanical and/or electrical decoupling of the system 110 from the vehicle 112, such as via the controller 130 of the system 110 and/or by an operator.

As also shown in FIG. 2, the UPS system 110 may also include at least one transportation mechanism or system 146 configured to physically transport the system 110 from the vehicle 112 when the system 110 is electrically, and potentially mechanically, decoupled from the vehicle 112. The at least one transportation mechanism 146 may be any mechanism or system that is effective in physically transporting at least the system 110, such as via over the ground and/or through the air. The at least one transportation mechanism or system 146 may include its own power source, controller or control system, interface, or any other component. The at least one transportation mechanism or system 146 may form a drone system that configures the system 110 as an autonomous drone UPS system 110.

The UPS system 110 may be configured to mechanically (and potentially electrically) removably or releasably couple to the at least one transportation mechanism or system 146 via a second controlled release mechanism 144 of the system 110, as shown in FIG. 2. The second release mechanism 144 may be configured to removably mechanically (and potentially electrically) couple and decouple the system 110 to the at least one transportation mechanism or system 146, such as when the system 110 is decoupled from the vehicle 112 (and/or while the system 110 is coupled with the vehicle 112. In some embodiments, the second release mechanism 144 may be in communication with the controller 130 of the system 110. In some such embodiments, the controller 130 may control operation of the second release mechanism 144 to effectuate or allow mechanical and electrical coupling and/or decoupling of the system 110 from the at least one transportation mechanism or system 146. From a coupled state, the second release mechanism 144 may thereby effectuate selective mechanical (and potentially electrical) decoupling of the system 110 from the at least one transportation mechanism or system 146, such as via the controller 130 of the system 110 and/or by an operator.

In this way, the system 110 may be decoupled (electrically and/or mechanically) from the vehicle 112 via the first release mechanism 142, and the at least one transportation mechanism or system 146 may be utilized to transport the system 110 to a second location that is remote or distal to the vehicle 112, such as a location where an uninterruptable power supply is needed or desired. For example, an uninterruptable power supply may be needed or desired during a medical emergency or any other situation that demands or requires electrical power while power (e.g., grid power) is not available, such as during a grid power failure or in locations where grid power is not available. In such a situation, once the system 110 is at the second location, the at least one transportation mechanism or system 146 may mechanically and electrically decouple from the system 110 via the second release mechanism 144 to allow the at least one transportation mechanism or system 146 to return to the vehicle 112 or any other location. For example, after the system 110 is delivered to the second location via the at least one transportation mechanism or system 146 and released therefrom via the second release mechanism 144, the at least one transportation mechanism or system 146 transport itself to a second location where at least one additional system 110 is located. The at least one additional system 110 and the at least one transportation mechanism or system 146 may couple to each other so that the at least one transportation mechanism or system 146 is able to transport the additional system 110 to the second location or a third location where an uninterruptable power supply may be needed or desired, for example.

The second energy storage device 24, which selectively couples with the first on-board energy storage device 16 by the DC interface 22 via the controller 30 as shown in FIG. 1, may include one or more electrical energy storage units. The second energy storage device 24 may be, or act as, the primary power source or supply of the uninterruptable electrical power supply. Stated differently, the load 32 from the AC power interface 28 may draw solely from the second energy storage device 24 if the second energy storage device 24 includes sufficient power and energy. If the draw on the second energy storage device 24 is greater than the second energy storage device 24 can provide, the remainder of the load 32 may be supplied by the first on-board energy storage device 16.

In some embodiments, the second energy storage device 24 may include a high-specific energy battery of an energy density of at least about 100 W-hr/kg (e.g., a sodium metal halide battery having an energy density of about 120 W-hr/kg, or a lithium-ion battery having an energy density of about 110 W-hr/kg) and/or a high-specific power battery having a power density of at least about 350 W/kg (e.g., a nickel cadmium battery having a power density of about 350 W/kg or greater, or a lithium-ion power battery having a power density of about 1,000 W/kg or higher). Additionally, second energy storage device 24 may include one or more ultracapacitor energy storage device. The ultracapacitor storage device(s) may be configured to increase power storage of the second energy storage device 24, thus allowing for vehicle-configured UPS 10 to provide higher pulsed power to an external load 32 via the interface 28 and operate for longer periods of time without utilizing the charging device 20 of the vehicle 12 for providing recharging power thereto, as explained further below.

As shown in FIG. 1, the DC-AC inverter 26 connected to the second energy storage device 24 may be configured to receive the DC power therefrom, and/or potentially the onboard first energy storage device 16 depending upon the load 32, and invert the DC power therefrom to an AC power useable by the external load 32 via the AC interface 28 Thus, for example, the DC-AC inverter 26 may be configured to receive a 12 V DC power from the second energy storage device 24 (and/or potentially the onboard first energy storage device 16) and convert that power to a 120 V AC power (or 230 V AC power for other applications or countries) for use by the external load 32. In another example, the DC-AC inverter 26 may be configured to receive a power other than 12 V DC power from the second energy storage device 24 (and/or potentially the onboard first energy storage device 16) and convert that power to a 120 V AC power for use by the external load 32. In some embodiments, the DC-AC inverter 26 may be configured to invert DC power from the second energy storage device 24 (and/or potentially the onboard first energy storage device 16) into AC power in the form of a pure sine wave. In some other embodiments, the DC-AC inverter 26 may be configured to invert DC power from the second energy storage device 24 (and/or potentially the onboard first energy storage device 16) into AC power in the form of a modified sine wave.

The conditioned AC power from the DC-AC inverter 26 may be available to a user via the AC power interface 28, as shown in FIG. 1. In this way, the interface 28 may allow for the connection of one or more external load(s) 32 to the power supply system. The interface 28 may include traditional outlets for plug and socket typed connections. The interface 28 may also include a manually engageable or controller actuated transfer switch or other mechanism configured to activate the UPS system 10 (e.g., via the controller 30).

As also shown in FIG. 1, the controller or control system 30 of the system 10 may be electrically coupled or in communication with the vehicle 12, the DC interface 22, the second energy storage device 24, the DC-AC inverter 26 and/or the AC power interface 28. As noted above, the controller 30 may control the DC interface 22 to selectively electrically decouple or couple the onboard first energy storage device 16 and the second energy storage device 24 to selectively provide a recharging power between (to/from) the onboard first energy storage device 16 to the second energy storage device 24 and/or power at least some of the load 32. The controller 30 may communicate with the DC-AC inverter 26 and/or the AC power interface 28 to monitor the status and/or condition of the current or load 32 passing therethrough.

As noted above, in some embodiments the controller may also be in communication with the second energy storage device 24 and/or the DC interface 22 of the system 10. In operation, the controller 30 may be configured to determine and/or directly sense a state-of-charge (SOC) and/or a voltage of the second energy storage system 24, and to maintain a SOC and/or voltage of the second energy storage system 24 within pre-determined minimum ranges or values of SOC and/or voltage to provide uninterruptable power to the DC-AC inverter 26, the AC interface 28 and, ultimately, the external load 32, as explained further below. The controller 30 may be configured to maintain the SOC and/or voltage of the second energy storage system 24 by controlling whether the DC interface 22 allows the recharging device 20 and/or the on-board first energy storage device 16 to apply a recharging power to the second energy storage device 24. Stated differently, the controller 30 may be configured to maintain the SOC and/or voltage of the second energy storage system 24 by activating or deactivating a recharging power from the recharging device 20 and/or the on-board first energy storage device 16 to the second energy storage device 24 (via the DC interface 22). Thus, upon activation of the DC interface 22, the recharging device 20 and/or the onboard first energy storage device 16 (e.g., an SLI battery) may provide power to the second energy storage device 24 (e.g., a high specific energy battery) as it is drained due to the external load 32 connected to the AC power interface 28. Further, the controller 30 may be configured to control the DC interface 22 such that the recharging device 20 and/or the on-board first energy storage device 16 supplies power to the external load 32 if the draw of the external load 32 is greater than what can be supplied by the second energy storage device 24 (i.e., rather than and/or in addition to a recharging power). The controller 30 may also be configured to determine and/or directly sense when the SOC and/or voltage of the second energy storage system 24 is raised back into the acceptable SOC and/or voltage range or level, and to deactivate the DC interface 22 such that the external load 32 and second energy storage device 24 are electrically isolated from the first on-board energy storage device 16 (i.e., just the second energy storage system 24 is used to power the external load 32). Additionally, as shown in FIG. 1 the controller 30 may be in communication with the first onboard energy storage device 16 and a cranking or starting motor 18 associated with an internal combustion engine 14 of the vehicle 12. The controller 30 may also be configured to determine and/or directly sense a state-of-charge (SOC) and/or a voltage of the on-board first energy storage system 16, and to maintain the SOC and/or voltage of the on-board first energy storage system 16 within a minimum range or value, as explained further below. The minimum range or value of the SOC and/or a voltage of the on-board first energy storage system 16 may correspond to a minimum sufficient SOC and voltage necessary to crank and start or initiate the internal combustion engine 14 of the vehicle 15 (e.g., via the starting mechanism 18) and, thereby, the charging system. Stated differently, the minimum range or value of the SOC and/or a voltage of the on-board first energy storage system 16 may ensure the on-board first energy storage system 16 has sufficient power and energy to crank and start or initiate the internal combustion engine 14 of the vehicle 12 (e.g., via the starting mechanism 18 and, thereby, the charging system. The minimum range or value of the SOC and voltage may be pre-determined, or may be actively determined based on environmental conditions, past performance of the internal combustion engine 14, user settings and/or any other factors.

The controller 30 may allow the on-board first energy storage system 16 to provide a recharging power to the second energy storage device 24 and/or provide power to the external load 32 to ensure an uninterruptable power supply, yet ensure the on-board first energy storage system 16 can initiate or operate the internal combustion engine 14. For example, if the on-board first energy storage system 16 is an SLI battery, the controller 30 may be configured to determine and/or directly sense the SOC and/or a voltage of the SLI battery 16, and to maintain the SOC and/or voltage of the SLI battery 16 within a range or above a value such that the SLI battery 16 is able to crank the internal combustion engine 14 at a sufficient speed for a sufficient amount of time (e.g., via the starter motor 18) in order to start and operate the engine 14 and/or vehicle 12 (e.g., even after extended operation of system 10). To maintain the SOC and/or voltage of the on-board first energy storage system 16, the controller 30 may selectively operate the charging device 20 of the vehicle 12 to provide for a recharging power to the on-board first energy storage system 16. That is, if the SOC and/or voltage of the on-board first energy storage system 16 is determined to be within an acceptable range or above a minimum value (e.g., above respective minimum values), the control system 30 may allow the on-board first energy storage system 16 to supply power to the second energy storage system 24 and/or the external load 32 via the DC interface 22 without activating the on-board charging device 20. If, however, the SOC and/or voltage of the on-board first energy storage system 16 is determined to be outside of an acceptable range or below a minimum value, then the controller 30 may activate the starting mechanism 20 of the vehicle 12 to activate the onboard charging device 20 of the vehicle 12 to provide recharging power to the on-board first energy storage system 16 to increase the SOC and/or voltage thereof.

An SOC threshold of the first and/or second energy storage device/system 16, 24 may be any metric that relates to the state-of-charge of the respective energy storage device/system 16, 24. For example, in some embodiments an SOC threshold of the first and/or second energy storage device/system 16, 24 may be measured/detected and/or represented as a percentage value in the range from zero to 100% (e.g., where 100% is fully charged and 0% is fully discharged). As another example, in some embodiments a voltage threshold of the first and/or second energy storage device/system 16, 24 may be measured/detected and/or represented as a value in Volts or in some cases it can be represented as a percentage of nominal voltage. For example, a 12 Volt nominal lead-acid battery may be charged to approximately 14.8 Volts or about 125% nominal voltage, and can be discharged to approximately 10.5 V or about 88% nominal voltage at its minimum operating range during discharge. It is noted that actual energy storage voltage of the first and/or second energy storage device/system 16, 24 may be dependent upon, or at least related to, the temperature and and/or recent charge/discharge history of the device/system 16, 24, for example.

Further, when the controller 30 activates the starting mechanism 18 of the vehicle 12 to activate the onboard charging device 20 of the vehicle 12 to provide recharging power to the on-board first energy storage system 16 to increase the SOC and/or voltage thereof, the controller 30 may be configured to operate the DC interface 22 to electrically disconnect or isolate the on-board first energy storage system 16 from the second energy storage system 24. In this way, the controller 30 may ensure the draw of the second energy storage system 24 and/or the external load 32 does not prevent the on-board first energy storage system 16 from cranking and starting the internal combustion engine 14, and thereby the onboard charging device 20, from maintaining the SOC and/or voltage of the onboard first energy storage system 16. The DC interface 22 may continue to electrically disconnect or isolate the on-board first energy storage system 16 from the second energy storage system 24 after starting of the internal combustion engine 14 (such as normally isolate the systems or isolate the systems 16, 24 for a relatively short period of time), and/or may electrically reconnect the on-board first energy storage system 16 and the second energy storage system 24 after starting of the internal combustion engine 14 or after SOC and/or voltage of the onboard first energy storage system 16 reaches a particular SOC and/or voltage, for example.

The controller 30 may thereby be configured to primarily or principally maintain the SOC and/or voltage of the onboard first energy storage system 16, and if the SOC and/or voltage of the onboard first energy storage system 16 is sufficient, maintain the SOC and/or voltage of the second energy storage system 24. The controller 30 may also be configured to determine and/or directly sense when the SOC and/or voltage of the on-board first energy storage system 16 is raised back into the acceptable range or level, and to turn off the internal combustion engine 14, and thereby the charging device or system 20, accordingly (and, potentially, activate the DC interface 22 such that the on-board first energy storage system 16 provides power to the second energy storage device 24, depending upon the SOC and/or voltage of the second energy storage device 24 and/or the draw of the external load 32).

For example, in some embodiments the controller or control system 30 of the UPS 10 may detect or determine at least one of a voltage and a state of charge (SOC) of each of the first and second energy storage systems. 16, 24. The controller 30 may detect or determine the at least one of a voltage and a state of charge (SOC) of each of the first and second energy storage systems 16, 24 at discrete intervals, continuously or at any other timeframe. If the controller 30 detects or determines that at least one of the voltage and the SOC of the first energy storage system 16 is below a first voltage threshold and/or SOC threshold, then the controller 30 may activate the internal combustion engine 14 and charging device/system 20 of the vehicle 12 coupled to the first energy storage system 16 to supply a recharging power thereto (potentially while at least the second energy storage system 24 provides power to the external load 32). The controller 30 may allow or effectuate the charging device/system 20 of the vehicle 12 to supply the recharging power to the first energy storage system 16 until the controller 30 detects or determines that at least one of the voltage and the SOC of the first energy storage system 24 is at or above a second threshold (potentially while at least the second energy storage system 24 provides power to the external load 32).

Similarly, if the controller 30 detects or determines that at least one of the voltage and the SOC of the of the second energy storage system 24 is below a third voltage threshold and/or SOC threshold (potentially while at least the second energy storage system 24 provides power to the external load 32), then the controller 30 may activate the internal combustion engine 14 and charging device/system 20 of the vehicle 12 coupled to the first energy storage system 16 to transfer DC electrical power from the first energy storage device 16 (potentially provided by the charging system/device 20) to the second energy storage device 24. If the controller 30 detects or determines that at least one of the voltage and the SOC of the of the second energy storage system 24 is below a third voltage threshold and/or third SOC threshold (potentially while at least the second energy storage system 24 provides power to the external load 32), then the controller 30 may also activate the DC interface 22 to electrically couple the first energy storage system 16 and the second energy storage system 24, if needed (such as if the DC interface 22 is currently electrically isolating the first and second energy storage systems 16, 24). The controller 30 may effectuate the transfer of DC electrical power from the first energy storage device 16 (potentially provided by the charging system/device 20) to the second energy storage device 24 until the controller 30 detects or determines that at least one of the voltage and the SOC of the second energy storage system 24 is at or above a fourth voltage threshold and/or a fourth SOC threshold while at least the second energy storage system 24 provides power to the external load 32.

The first, second, third and/or fourth voltage and/or SOC thresholds may be predetermined values (e.g., preprogrammed) or determined values. The first, second, third and/or fourth thresholds may also be fixed values or dynamic or variable values that may change over time. When variable and/or dynamically determined, the first, second, third and/or fourth thresholds may be based any number of different factors or considerations that would optimize the system 10. For example, when variable and/or dynamically determined, the first, second, third and/or fourth thresholds may be based, at least in part, on environmental conditions (e.g., temperature), current load on the respective energy storage system 16, 24, prior loads on the respective energy storage system 16, 24 (e.g., prior power and/or energy utilized to start the internal combustion engine 14), particular use of the UPS 10, prior or current performance of the respective energy storage system 16, 24, etc., for example.

The controller 30 of the system 10 may be configured to selectively activate the internal combustion engine 14 of a vehicle 12 to run the recharging device 20 thereof and recharge its first energy storage device 16, such as an SLI battery. More specifically, when system 10 is activated and when a sensed/determined SOC and/or voltage of the SLI battery 16 is determined to be outside an acceptable range or below a minimum value, the controller 30 may be configured to activate the internal combustion engine 14 by the starter motor 18 (e.g., via a remote starter mechanism 34) to run the recharging device 20 and supply a recharging power thereto. The controller 30 may continue to measure the SOC and/or voltage of the SLI battery 16 as power is being transferred thereto by the internal combustion engine 14 and/or recharging device 20. Thus, when the SOC and/or voltage of the SLI battery 16 is raised back into the acceptable range, the controller 30 may deactivate the internal combustion engine 14 to deactivate the recharging device 20, and stored energy from the SLI battery 16 can again be used to recharge the second energy storage device 24 and/or power the external load 32, if needed.

The controller 30 may be in communication with the starting mechanism 18 of the vehicle 12 to selectively operate the starting mechanism 18 to start the internal combustion engine 14 and, thereby, the charging device 20 to maintain the SOC and/or voltage of the on-board first energy storage system 16 via any manner. For example, as shown in FIG. 1 the controller 30 may communicate wirelessly or through a wired connection with a remote starting mechanism 34 of the vehicle 12 that is configured to effectuate starting, and potentially stopping, of the engine 14 of the vehicle 12 (e.g., via the start motor 18 and vehicle ignition system) to initiate a start and/or stop command 36. The remote starting mechanism 34 of the vehicle 12 may thereby be configured to operate the starter mechanism 18 via a starting command 36 or otherwise place the vehicle 12 in a condition to start the internal combustion engine 14 and, thereby, the charging device 20, as shown in FIG. 1. The remote starting mechanism 34 may be electrically coupled with the vehicle 12 via a wired and/or wireless connection. In this way, the controller 30 may utilize the remote starting mechanism 34 of the vehicle 12 (or an after-market remote starter device added to the vehicle 12) to start the engine 14 via start command 36 to selectively charge the onboard first energy storage system 16. It is noted that an operator may also be able to send a start command 36 to the remote starting mechanism 34 via wired or wireless communication to start the engine 14 of the vehicle 12 to selectively start the engine 14 and/or charge the onboard first energy storage system 16. The remote starting mechanism 34 of the vehicle 12 may also be configured to sense and/or determine the SOC and/or voltage of the onboard first energy storage system 16. In such embodiments, the controller 30 may utilize the remote starting mechanism 34 of the vehicle 12 to, at least in part, sense and/or determine the SOC and/or voltage of the onboard first energy storage system 16. In some embodiments, the remote starting mechanism 34 may form part of the system. As another example, the controller 30 may be coupled to the starter mechanism 18, the control unit of the internal combustion engine 14 of the vehicle 12, and/or any other aspect of the vehicle 12 to selective start the internal combustion engine 14 and, thereby, the charging device 20 to maintain the SOC and/or voltage of the on-board first energy storage system 16.

In some embodiments, when the internal combustion engine 14 of the vehicle 12 is not running and thereby the charging mechanism 20 is not charging the on-board first energy storage device 16, or when the internal combustion 16 is running and the charging mechanism 20 is not charging the on-board first energy storage device 14 (e.g., when the controller 30 has not determined that the SOC and/or voltage of the first on-board energy storage system 16 is below the minimum range or value), the DC interface 22 may electrically couple the on-board first energy storage device 16 and the second energy storage device 24 to allow or provide for the transfer of DC electrical power between the first energy storage device 16 and the second energy storage device 24, if needed, for example. For example, if the external load 32 cannot be met by the second energy storage system 24, the first on-board energy storage system 16 may thereby provide such needed power. Further, the first onboard energy storage system 16 may provide a recharging power to the second energy storage system 24, if need be, under certain other conditions.

In such embodiments, when the controller 30 determines the SOC and/or voltage of the first on-board energy storage system 16 is below the minimum range or value (as described above), the DC interface 22 may electrically isolate the on-board first energy storage device 16 from the second energy storage device 24 via the DC interface 22 and activate the internal combustion engine 16 and/or charging mechanism 20 to recharge the on-board first energy storage device 16, as described above. The on-board first energy storage device 16 may remain isolated from the second energy storage device 24 via the DC interface 22 for a relatively short period of time after the activation of the internal combustion engine 14 and/or charging mechanism 20. Thereafter, the DC interface 20 may electrically couple the on-board first energy storage device 16 and the second energy storage device 24 to allow or provide for the transfer of DC electrical power between the first energy storage device 16 and the second energy storage device 24.

In some other alternative embodiments, when the internal combustion engine 14 of the vehicle 12 is not running and thereby the charging mechanism 20 is not charging the on-board first energy storage device 16, or when the vehicle 12 is running and the charging mechanism 20 is not charging the on-board first energy storage device 16 (e.g., when the controller 30 has not determined that the SOC and/or voltage of the first on-board energy storage system 16 is below the minimum range or value), the DC interface 22 may electrically isolate the on-board first energy storage device 16 and the second energy storage device 24 via the DC interface 22. As such, in some embodiments the controller 30 may electrically couple the on-board first energy storage device 16 and the second energy storage device 24 via the DC interface 22 to supply a recharging power to the second energy storage device 24 when the controller 30 determines the SOC and/or voltage of the second energy storage device 24 indicates that the second energy storage device 24 needs recharging and the controller 30 determines the SOC and/or voltage of the first on-board energy storage device 16 indicates the first energy storage device 16 does not need recharging.

As shown in FIG. 1, the controller 30 may include inputs from at least one sensor 38 and/or other components of the vehicle 12 and/or the system 10. For example, the controller 30 may receive an input from an ignition switch or a separate switch included in vehicle 12, such as a dash mounted switch. When such a switch is set to a particular mode, the controller 30 may activate the system 10 such that the system 10 provides power to an external load 32 by way of an AC power interface 28, as described above. The at least one sensor 38 may provide information to the controller 30 on a plurality of vehicle-related parameters that may affect, optimize and/or control operation of the system 10. For example, the SOC and/or voltage of the on-board first energy storage device 16 and/or the second energy storage device 34 may be measured and or determined based on sensed metrics thereof by the at least one sensor 38, such as at various times during operation of the system 10. Based on a sensed SOC and/or voltage of the on-board first energy storage system 16 and/or the second energy storage device 24 via the at least one sensor 38, the controller 30 may operate the system 10 such that recharging power is provided to the first energy storage system 16 and/or the second energy storage device 24 and operate the internal combustion engine 14, charging device 20, and/or DC interface 22 accordingly, as described above.

As another example, the at least one sensor 38 of the system 10 may include a transmission gear status sensor. In such embodiments, the controller 30 may receive input from a transmission gear status sensor 38 of the vehicle 12 indicating the gear (i.e., one of PRNDL states) in which vehicle 12 is presently engaged. In another example, the at least one sensor 38 of the system 10 may include a parking brake engagement status sensor. A parking brake engagement status sensor 38 can also provide information as to whether the vehicle's 12 parking brake is engaged. As a further example, the at least one sensor 38 of the system 10 may include a fuel level sensor. The fuel level sensor 38 may measure/determine a level of fuel remaining for the engine 14, such as a level of gasoline, diesel, or natural gas fuel. In such exemplary embodiments, only if the information provided by these sensors 38 to the controller 30 indicate that the vehicle 12 is in a “Park” gear, and/or that the vehicle's 12 parking brake is engaged, and/or that the fuel level of the vehicle 12 is at an acceptable level, the controller 30 may allow for activation of the system 10 to provide power to the external load 32 and recharge the on-board first energy storage system 16 and the second energy storage device 24 based on the SOCs/voltages thereof, as described above.

In some embodiments, the at least one sensor 38 of the system 10 may include a carbon monoxide (CO) sensor. In such embodiments, the controller 30 may receive input from the carbon monoxide (CO) sensor 38 that provides data regarding the level of CO in the vicinity of the vehicle 12 and whether that level is above a certain threshold limit. In the event that the CO sensor 38 detects/determines a CO level exceeding a pre-determined threshold, the controller 30 may be configured to activate an alarm and/or automatically shut down or deactivate operation of the system 10, the internal combustion engine 14 of the vehicle, and/or the charging device 20 of the vehicle 20. In some embodiments, the controller 30 may be configured to generate an alarm based on the sensed CO level (or low fuel level, for example) to alert an operator of such an occurrence.

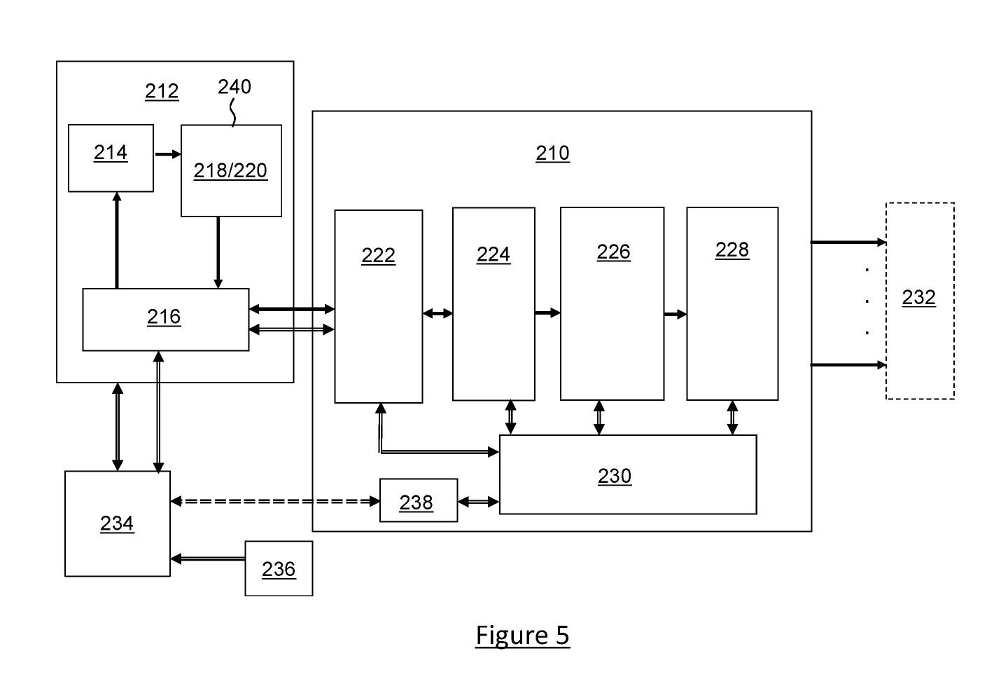

FIG. 5 illustrates another exemplary embodiment of a vehicle- and/or engine-based power supply system or uninterruptable power supply (UPS) system 210 of the present disclosure. The exemplary UPS system 210 of FIG. 5 is substantially similar to the exemplary UPS system 10 of FIGS. 1, 3 and 4, and the exemplary UPS system 110 of FIG. 2, and therefore like reference numerals preceded by the numeral “2” are used to indicate like elements. The description above with respect to the exemplary UPS system 10 of FIGS. 1, 3 and 4, and the exemplary UPS system 110 of FIG. 2, equally applies to the exemplary UPS system 210 of FIG. 5, including description regarding alternative embodiments thereto (i.e., modifications, variations or the like). The exemplary UPS system 210 of FIG. 5 differs from the exemplary UPS systems 10 and 110 with respect to the configuration of the operation of the internal combustion engine 214 and the recharging of the on-board first energy storage system 216.

As shown in FIG. 5, the starting mechanism 218 (e.g., a starter motor) and the recharging mechanism 220 (e.g., an alternator) of the vehicle 12 and/or the system 210 may be configured as a combined starting, cranking and recharging mechanism 240 operable to both start, activate or initiate operation of the internal combustion engine 214 and recharge the on-board first energy storage system 216. For example, the combined starting, cranking and recharging mechanism 240 may crank the engine 214 utilizing power from the on-board first energy storage system 216 to start the engine 216, and, once the engine 214 is running on fuel, utilize the engine 214 to produce electrical power to recharge the on-board first energy storage system 216.

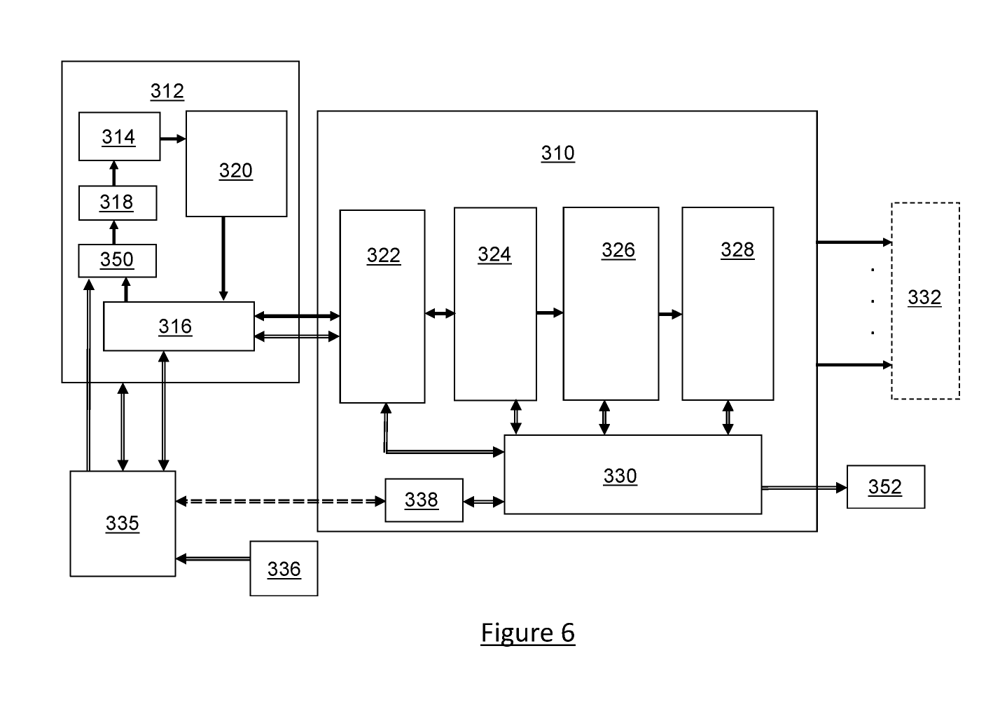

FIG. 6 illustrates another exemplary embodiment of a vehicle- and/or engine-based power supply system or uninterruptable power supply (UPS) system 310 of the present disclosure. The exemplary UPS system 210 of FIG. 5 is substantially similar to the exemplary UPS system 10 of FIGS. 1, 3 and 4, the exemplary UPS system 110 of FIG. 2, and the exemplary UPS system 210 of FIG. 5, and therefore like reference numerals preceded by the numeral “3” are used to indicate like elements. The description above with respect to the exemplary UPS system 10 of FIGS. 1, 3 and 4, the exemplary UPS system 110 of FIG. 2, and the exemplary UPS system 210 of FIG. 5, equally applies to the exemplary UPS system 310 of FIG. 6, including description regarding alternative embodiments thereto (i.e., modifications, variations or the like). The exemplary UPS system 310 of FIG. 6 differs from the exemplary UPS systems 10, 110 and 210 with respect to the configuration of the operation of the activation of the internal combustion engine 314 and/or the system 310 to recharge the on-board first energy storage system 316.

As shown in FIG. 6, the vehicle 312 and/or system 310 may include a manual start switch or mechanism 335 that is configured to initiate cranking and starting the engine 314 of the vehicle 312. The manual start mechanism 335 may require manual interaction by the operator to activate the system 310, as described above. As shown in FIG. 6, the manual start mechanism 335 may be electrically coupled with a contactor 350. The contactor 350 may be positioned electrically between the on-board first energy storage device 316 and the starting mechanism 318 of the vehicle 312, as shown in FIG. 6. In some embodiments, the contactor 350 may be configured allow and/or prevent starting, cranking and/or operation of the internal combustion engine 314 depending upon the state of the manual key switch/start mechanism 335. In some embodiments, the contactor 350 may be configured to initiate cranking or starting of the internal combustion engine 314, while the manual key switch/start mechanism 335 in communication with vehicle ignition system (not shown) provides starting and/or stopping of the internal combustion engine 314 and recharging system 320, depending upon the state of the manual start mechanism 335.

As also shown in FIG. 6, the system 310 may include an indicator 352 that provides an indication to the operator regarding the state of the system 310 and/or the vehicle 312. In some embodiments, the indicator 352 may be configured to provide a visual indication (e.g., a light). The system 310 may be configured to be manually (as opposed to automatically) operated or initiated by a user (e.g., when the vehicle 312 is purposefully started by a user and/or via a manual switch or other mechanism), and the indicator 352 may provide an indication as to the state of the system 310 and/or the first energy storage device 316, for example. In this way, the system 310 may be selectively operated by the user, and the indicator 352 may provide an indication to the user regarding a state of the system 310 and/or the first energy storage device 316 that may urge or instruct the user to start and/or stop the system 310 and/or the vehicle 312.

The indicator 352 may be configured to provide an indication as to if the first and/or second energy storage device 316, 324 of the system 310 needs recharging, as described above. In some embodiments, the indicator 352 may be configured to provide an indication when the second energy storage device 324 of the system 310 is being recharged by the onboard first energy storage device 316 and/or recharging system 320 of the vehicle 312, as described above. Further, the indicator 352 may be configured to provide an indication as to if any necessary parameters and/or conditions required by the controller 330 to initiate recharging of the second energy storage device 324 are met or satisfied (e.g., at least one sensed/determined parameter or condition via the at least one sensor 338 is satisfactory), as described above. In some embodiments, the indicator 352 may be configured to provide an indication when the second energy storage device 324 of the system 310 is being recharged by the onboard first energy storage device 316 and/or recharging system 320 of the vehicle 312, as described above.

While various embodiments of vehicles and power supply systems are shown and described in FIGS. 1-6, it is envisioned that other forms and configurations of the vehicles and power supply systems can also be included in the vehicle-based power supply systems of the present disclosure without departing from the sprit and scope of the present application.

For example, in some embodiments (not shown) the on-board first energy storage system may not operate to start, activate or initiate operation of the internal combustion engine of the vehicle. Rather, the on-board first energy storage system may be utilized to power an auxiliary system or device of the vehicle (rather than being part of the internal combustion engine) (e.g., a generator or other electricity production), such as air conditions/heat system, entertainment systems, lighting, etc. As another example, the on-board first energy storage system may be utilized to startup a generator or other electricity production device (e.g., in a similar manner as the startup of an internal combustion engine, as described above), and the vehicle's internal combustion engine and/or the generator or other electricity production device may be utilized to recharge the on-board first energy storage system. The system may thereby be adapted to selectively operate the particular mechanism of the vehicle utilized to recharge the on-board first energy storage system based on the SOC and/or voltage thereof as described above.

A technical contribution for the disclosed systems and related methods is that it provides for a controller implemented technique for controlling operation of an internal combustion engine of a vehicle for a vehicle-based uninterruptable power supply system. The control system of the power supply system may control operation of an on-board first energy storage system and on-board charging device(s) of the vehicle, and a second energy storage system of the power supply system, so as to provide uninterruptable power to an external load and maintain a voltage and/or SOC of the first and/or second energy systems within an acceptable range or above minimum values, for example.

In the illustrated exemplary UPS system embodiments of FIGS. 1-6, double-lined arrows are used to indicate control or communication signals transmitted to and/or between elements or aspects of the systems as indicated by the arrows. At least some of these control or communication signals may be initiated and/or controlled by the controller of the system and/or an operator. In the illustrated exemplary UPS system embodiments of FIGS. 1-6, double-lined dashed arrows are used to indicate control or communication signals that are transmitted wirelessly. However, any control or communication signals and any other signals to and/or between elements or aspects of the systems, as indicated in FIGS. 1-6 by arrows, may be wireless signals or signals passing through/over at least one wired connection.

It is to be understood that the above description is intended to be illustrative, and not restrictive. Numerous changes and modifications may be made herein by one of ordinary skill in the art without departing from the general spirit and scope of the invention as defined by the following claims and the equivalents thereof. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Also, the term “operably connected” is used herein to refer to both connections resulting from separate, distinct components being directly or indirectly coupled and components being integrally formed (i.e., monolithic). Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the disclosure may include only some of the described embodiments. Accordingly, the invention is not to be seen as limited by the foregoing description, but is only limited by the scope of the appended claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

I claim:

1. An uninterruptable power supply (UPS) system for use with a vehicle with an internal combustion engine, an onboard first energy storage device configured to store and provide DC electrical power for at least one of cranking and starting the engine of the vehicle and powering auxiliary devices of the vehicle, and a charging device configured to provide a recharging power to the first energy storage device, the system comprising:
a second energy storage device configured to store and provide DC electrical power;
a DC interface electrically coupled between the first energy storage device and the second energy storage device configured to control the transfer of DC electrical power between the first energy storage device and the second energy storage device;
a DC-AC inverter electrically coupled to the second energy storage system configured to receive the DC power therefrom and invert the DC power to AC power;
an AC power interface electrically coupled to the DC-AC inverter configured to receive the AC power therefrom and provide an electrical connection to an external load; and
a control system configured to:
cause the AC power interface to provide uninterrupted AC power to the external load from at least the second energy storage device;
determine at least one of a state-of-charge (SOC) and a voltage of each of the first energy storage system and the second energy storage system while the uninterrupted AC power is provided to the external load;
based on the at least one of the SOC and the voltage of the first energy storage system, selectively operate the internal combustion engine and the charging device of the vehicle to provide the recharging power to the first energy storage system to maintain at least one of the SOC and the voltage of the first energy storage system at or above a first threshold; and
based on the at least one of the SOC and the voltage of the second energy storage system, selectively operate the internal combustion engine and the charging device of the vehicle and the DC interface to provide the recharging power to the first energy storage system and to transfer the DC electrical power from the first energy storage system to the second energy storage system to maintain the at least one of the SOC and the voltage of the second energy storage system at or above a second threshold.

2. The UPS system of claim 1, wherein the first energy storage device comprises at least one starting-lighting-ignition (SLI) battery with a reserve capacity of at least 80 minutes and at least 500 cold cranking amperes.

3. The UPS system of claim 1, wherein the second energy storage device comprises at least one battery.

4. The UPS system of claim 3, wherein the second energy storage device comprises at least one high-specific energy battery or a high-specific power battery.

5. The UPS system of claim 3, wherein the second energy storage device further comprises at least one ultracapacitor energy storage device.

6. The UPS system of claim 1, wherein the control system is configured to determine the SOC and the voltage of each of the first energy storage system and the second energy storage system while the uninterrupted AC power is provided to the external load.

7. The UPS system of claim 6, wherein the control system is configured to, based on the SOC and the voltage of the first energy storage system, selectively operate the internal combustion engine and the charging device of the vehicle to provide the recharging power to the first energy storage system to maintain the SOC and the voltage of the first energy storage system at or above a first threshold of the SOC and a first threshold of the voltage of the first energy storage system.

8. The UPS system of claim 6, wherein the control system is configured to, based on the SOC and the voltage of the second energy storage system, selectively operate the internal combustion engine and the charging device of the vehicle and the DC interface to provide the recharging power to the first energy storage system and to transfer the DC electrical power from the first energy storage system to the second energy storage system to maintain the SOC and the voltage of the second energy storage system at or above a second threshold of the SOC and a second threshold of the voltage of the second energy storage system.

9. The UPS system of claim 1, wherein the DC interface electrically decouples or substantially reduces the level of DC electrical power transfer from the on-board energy storage system to the second energy storage system while the onboard first energy storage device provides DC electrical power for at least one of cranking and starting the engine of the vehicle.

10. The UPS system of claim 1, wherein the control system is at least one of activated and deactivated by a user via a wired or wireless switch.

11. The UPS system of claim 1, wherein the control system is configured to at least one of automatically deactivate and automatically reactivate after a deactivation based on at least one sensed parameter.

12. The UPS system of claim 1, wherein the DC interface is at least one of a MOSFET transistor and a DC-DC converter.

13. The UPS system of claim 1, wherein the system is configured to mechanically and electrically fixedly couple to the vehicle.

14. The UPS system of claim 1, wherein the system is configured to electrically removably couple to the vehicle.

15. The UPS system of claim 14, further comprising a transportation system configured to physically transport the system from the vehicle to a location remote from the vehicle when the system is electrically decoupled from the vehicle.

16. The UPS system of claim 1, further comprising the vehicle.

17. A method for supplying uninterruptable power comprising:
detecting connection of an external load to an uninterruptable power supply (UPS) system coupled to a first energy storage system of a vehicle configured to store and provide DC electrical power for at least one of cranking and starting an engine of the vehicle and powering auxiliary devices of the vehicle;
providing AC power from at least a second energy storage system of the UPS system to the external load;
detecting at least one of a voltage and a state of charge (SOC) of each of the first and second energy storage systems;
if the at least one of the voltage and the SOC of the first energy storage system is below a first threshold, then activating a charging device of the vehicle coupled to the first energy storage system to supply a recharging power thereto until the at least one of the voltage and the SOC of the first energy storage system is at or above a second threshold while at least the second energy storage system provides power to the external load; and if the at least one of the voltage and the SOC of the second energy storage system is below a third threshold, then activating the charging device of the vehicle and activating a DC interface of the UPS system coupled between the first energy storage system and the second energy storage system to transfer DC electrical power from the first energy storage device to the second energy storage device until the at least one of the voltage and the SOC of the second energy storage system is at or above a fourth threshold while at least the second energy storage system provides power to the external load.

18. A control system for controlling the supply of uninterrupted power from a first energy storage system of an uninterruptable power supply (UPS) system to an external load, the UPS system coupled to a vehicular on-board second energy storage system, the control system programmed to:
detect connection of the external load to the first energy storage system of the UPS system;
measure at least one of a voltage and a state of charge (SOC) of the first energy storage system upon connection of the external load;
measure at least one of a voltage and a state of charge (SOC) of the second energy storage system;
selectively activate a vehicular charging device connected to the second energy storage system if the at least one of the voltage and the SOC thereof is at or below a first threshold to supply a recharging power thereto until the at least one of the voltage and the SOC of the second energy storage system is at or above a second threshold; and
selectively activate the vehicular charging device and selectively activate a DC interface of the UPS system coupled between the first energy storage system and the second energy storage system if the at least one of the voltage and the SOC of the first energy storage system is at or below a third threshold to supply a recharging power thereto until the at least one of the voltage and the SOC of the first energy storage system is at or above a fourth threshold while at least the first energy storage system provides uninterrupted power to the external load.

19. The control system of claim 18, further programmed to be at least one of activated and deactivated by a user via a wired or wireless switch.

20. The control system of claim 18, further programmed to at least one of automatically deactivate and automatically reactivate after a deactivation based on at least one sensed parameter.
